(19) United States
(12) Patent Application Publication
(10) Pub. No.: US 2002/0114985 A1
(43) Pub. Date: Aug. 22, 2002

(54) Stationary energy center

(76) Inventors: Nikolay Shkolnik, West Hartford, CT (US); Sergey Anatolievich Logvinov, Saint Petersburg (RU); Pavel Yurievich Koblents, Saint Petersburg (RU); Andrey Nikolaevich Shliakhtenko, Sosnovy Bor (RU); Sam Kogan, Newton Center, MA (US); Dmitry Ivanovich Pivunov, Saint Petersburg (RU); Vasily Gennadievich Abashkin, Saint Petersburg (RU)

Correspondence Address: STANGER & DREYFUS, 608 SHERWOOD PKWY, MOUNTAINSIDE, NJ, 07092, US

(21) Appl. No.: 10/051,613

(22) Filed: Jan. 17, 2002

Related U.S. Application Data
(60) Provisional application No. 60/262,877, filed on Jan. 17, 2001.

(51) Int. Cl. H01M 8/06; H01M 8/04; H01M 8/02

(52) U.S. Cl. 429/20; 429/26; 429/38

(57) ABSTRACT

A stationary power plant intended for use in houses and industrial or commercial buildings includes a high temperature fuel cell, a reformer for converting hydrocarbon fuel into a fuel mixture of hydrogen and carbon monoxide, a combustion chamber, and a volume expansion engine. The fuel mixture from the reformer enters the fuel cell, where it is processed along with oxygen from the air to produce electricity. The hot gases exiting the fuel cell, including unprocessed fuel, are passed to the combustion chamber where the fuel remnants are burned resulting in better fuel efficiency. The exhaust from the combustion chamber drives the volume expansion engine. The fuel cell, combustion chamber and volume expansion engine combination provides better dynamic load response than other fuel-cell-based power plants. One example of an entire building fuel cell power plant is disclosed which can operate in various modes to drive or thermally modify building water, air, sewage, and/or electricity.

### RELATED APPLICATIONS

Priority is claimed to U.S. Provisional Patent Application SNO. 60/262,877 filed Jan. 17, 2001.

### FIELD OF THE INVENTION

The invention refers to stationary power plants based on high temperature fuel cells, which are predominantly intended for use in houses or industrial or commercial buildings.

### BACKGROUND OF THE INVENTION

High temperature fuel cells efficiently convert the chemical energy of fuels into electric power via an electrochemical reaction between the fuel (usually a mixture of hydrogen and carbon monoxide) and air (oxygen). Electric power is produced as a result of said interaction. However, conversion of the fuel is generally incomplete, so the remnants of fuel, together with oxidation products, are generally used in engines that produce additional electric and mechanical power (co-generation). The heat produced by the fuel cell is also used, for example, to heat water or air needed by houses or industrial buildings.

Power plants are known in which unused fuel from high temperature fuel cells is utilized by a gas turbine. As an example, see the inventions described in Japanese patent #63,119,163 “Fuel cell generating system” (priority date Nov. 7, 1986; publication date May 23, 1988; IPC H01M 8/06); Japanese patent #4,065,066 “Fuel cell and carbon dioxide gas fixed compound power generation method” (priority date Jul. 5, 1990, publication date Mar. 2, 1992, IPC H01M 8/06); Japanese patent #1,021,463 “Device and method of reproducing electricity and by-producing hydrogen” (priority date Dec. 19, 1996, publication date Aug. 11, 1998, IPC H01M 8/00), and U.S. Pat. No. 5,541,014 “Indirect-fired gas turbine dual fuel cell power cycle” (priority date Oct. 23, 1995, publication date Jul. 30, 1996, IPC H01M 8/06).

Systems are also known in which electric power produced by a fuel cell and heat produced in the system are used to cover the utility needs of buildings and structures. As an example, see U.S. Pat. No. 6,054,229 “System for electric generation, heating, cooling, and ventilation” (priority date Jun. 2, 1997, publication date Apr. 4, 2000, IPC H01M 8/04); U.S. Pat. No. 5,924,287 “Domestic energy supply system” (priority date Mar. 12, 1996, publication date Jul. 20, 1999, IPC F01K 27/00), and Japanese patent application #61,191,824 “Fuel cell power generation type hot water supplier for space cooling and heating” (publication date Aug. 26, 1986, IPC F24H 1/00).

These power plants are intended for use only as stationary power plants. However, the problem of how to efficiently utilize the fuel consumed by a power plant which includes a fuel cell was not fully resolved in these systems.

The closest analogue to the invention being claimed herein is U.S. Pat. No. 5,985,474 “Integrated full processor, furnace, and fuel cell system for providing heat and electrical power to a building” (priority date Aug. 26, 1998, publication date Nov. 11, 1999, IPC H01M 8/06), which was chosen as a prototype for the present invention.

This integrated system, which is intended to supply heat and electric power to buildings, comprises a reformer, a fuel cell (the source of electric power), a combustion chamber (intended for heat production), and a heat exchanger (intended for heating water used in the heating system of a building). However, this power plant is not efficient enough for dynamic operation.

### BRIEF SUMMARY OF THE INVENTION

The invention claimed herein solves the problem of efficient utilization of hydrocarbon fuel for a dynamically loaded power plant for houses or industrial buildings, which produces electric and thermal energy.

Two designs for the present invention intended to solve said problem are claimed herein.

The first power plant design comprises a reformer intended for the conversion of hydrocarbon fuel into a mixture of hydrogen and carbon monoxide; a high temperature fuel cell having both an air duct with an inlet and outlet, and a fuel supply channel with an inlet and outlet; a combustion chamber with a fuel supply inlet, air supply inlet and an outlet; and a volume expansion engine with an inlet which serves to supply the working medium.

The outlet of the reformer is connected to the inlet of the fuel supply channel of the fuel cell. The outlet of the fuel supply channel of the fuel cell is connected to the fuel supply inlet of the combustion chamber. The outlet of the air duct of the fuel cell is connected to the air inlet of the combustion chamber. The outlet of the combustion chamber is connected to the inlet of the volume expansion engine. The combustion chamber may be arranged as a separate unit or as a part of the engine.

Hydrocarbon fuel is fed to the reformer where it is converted into a mixture of hydrogen and carbon monoxide that serves as a fuel for the high temperature fuel cell. Said mixture of hydrogen and carbon monoxide is then fed to the fuel supply channel of the fuel cell, while air is fed to the air duct of the fuel cell. The fuel cell is where conversion of chemical energy into electric energy takes place. This conversion proceeds via electrochemical reactions involving air (oxygen), hydrogen and carbon monoxide. Hydrogen and carbon monoxide that remain unused in the course of the electrochemical conversion, together with the oxidation products from the reaction, are then fed to the combustion chamber. Oxygen that hasn't been used in the high temperature fuel cell is also supplied to the combustion chamber. Open or catalytic exothermic burning of the remnants of hydrogen and carbon monoxide takes place in the combustion chamber. Said burning increases the temperature of the gases. The hot gases exiting the combustion chamber are directed to the volume expansion engine where they perform mechanical work.

Volume expansion engines (e.g. piston engines, rotary engines, free-piston engines and the like) operate quite well under dynamic loads. Thus, when it is necessary to rapidly change the power of a power plant, one should feed greater amounts of fuel and air to the high temperature fuel cell. Since they will not be converted to electric power in the said high temperature fuel cell, they will be burned in the combustion chamber. This will increase the power output of the power plant as a whole, because of the work performed by the volume expansion engine. In this process, the high temperature fuel cell provides a certain nominal power of the power plant, which is close to the average power demand, while peak demands will be covered with the aid of the volume expansion engine. In addition, utilizing the volume expansion engine to process the remnants of fuel leftover from the high temperature fuel cell always increases the overall efficiency of a power plant.

In a particular embodiment of the power plant, a combustion chamber may be connected to the reformer via a heat exchanger for the purpose of heating the reformer. This approach offers two advantages: first, a higher reformer temperature intensifies the conversion processes of hydrocarbon fuel into hydrogen and carbon monoxide; second, removing a portion of heat from the combustion chamber reduces the temperature of the combustion products. Therefore, a standard volume expansion engine, rather than one that is specially designed for high temperature operation, can be used in the power plant. This is desirable from an engineering standpoint, and results in decreased losses in the volume expansion engine.

In the power plant claimed herein, a high temperature fuel cell produces electric power, which then supplies power to a house or industrial building. An engine drives the electrical generator, auxiliary devices of the power plant, and/or devices required for the functioning of the HVAC systems of the building.

Heat exchangers may be installed on said high temperature fuel cell to further heat fuel fed to the reformer and air supplied to the high temperature fuel cell. Installation of said heat exchangers would increase the power plant efficiency.

A system of heat exchangers may be installed at the exhaust outlet of the volume expansion engine to heat water to be used, for example, for a hot water supply system; and/or to heat air to be used in an air conditioning system; and/or to heat air to be fed to the air duct of the power plant.

A volume expansion engine may be mechanically connected to an electric generator for the purpose of producing additional electric power. The additional power may either be used immediately or stored in accumulators.

In addition, the engine may also be used to drive a compression refrigerating plant that supplies cold or hot air to the building. In this case, said compression refrigerating plant may comprise a compressor driven by the engine, a condenser, a throttling device, and an evaporator. The compression refrigerating plant can operate as either a refrigeration plant or a heat pump.

When the compression refrigerating plant operates in refrigerating plant mode an evaporator serves to cool air in the building. In this case, a condenser of the refrigerating plant serves to heat water used, for example, in water supply systems.

When the compression refrigerating plant operates in heat pump mode, its evaporator may have thermal contact with airflow exiting the ventilation system for the building. In this case the energy contained in the hot (or warm) air is recycled to the system and can be utilized, for example, to heat water to be used later in the hot water and water supply systems. In this case the power plant efficiency is increased by recuperating energy consumed during the operation of various household appliances which evaporate water when operated (drying machines, electric irons, hair driers and the like).

In a particular embodiment of the power plant, the evaporator of the compression refrigerating plant may be made so that it is in thermal contact with the sewage collecting system of the building, from which heat can be recovered and returned to the power system.

A reversible electric machine operating in electric generator mode may be used as an electric generator. When necessary, switching this machine to electric motor mode will make it possible to increase the refrigerating plant capacity, thus covering peak demands for cold.

In the preferred embodiment of the present invention, a volume expansion engine, a compression refrigerating plant, a compressor, and a reversible electric machine (which operates in generator mode when the demand for electric power is high, and as an electric motor that, together with volume expansion engine, drives the compressor of the compression refrigerating plant when the demand for cold increases) are combined into a single unit.

The power of a high temperature fuel cell should be selected so that it is no greater than 50% of the power of the volume expansion engine. Since high temperature fuel cells are quite expensive, it is preferable to size it to match the average power. Then peak demand will be covered by the combined operation of the volume expansion engine with the electric generator. In this case, the system will have the optimal cost-to-power characteristics.

The second power plant design results in greater power plant controllability under dynamic loads. It comprises a reformer which converts hydrocarbon fuel into a mixture of hydrogen and carbon monoxide; a high temperature fuel cell with an air duct with an inlet and outlet, and a fuel supply channel with an inlet and outlet; a distributor having one inlet and two outlets; a combustion chamber with a fuel supply inlet, air supply inlet and an outlet; and a volume expansion engine having an inlet that serves to supply the working medium.

The outlet of the reformer is connected to the inlet of the fuel supply channel of the high temperature fuel cell. The outlet of the fuel supply channel is connected to the fuel supply inlet of the combustion chamber via the distributor, while the outlet of the air duct of the fuel cell is connected to the air supply inlet of said combustion chamber. One outlet of the distributor is also connected to the reformer inlet. The other outlet of the distributor is connected to the inlet of the reformer, while the outlet of the combustion chamber is connected to the inlet of the volume expansion engine.

As with the first design, hydrocarbon fuel is fed to the reformer where it is converted into a mixture of hydrogen and carbon monoxide that serves as a fuel for the high temperature fuel cell. Hydrogen and carbon monoxide are then fed to the fuel supply channel of the fuel cell, while air is fed to the air duct. Conversion of chemical energy into electric energy takes place in the fuel cell, via electrochemical reactions involving air (oxygen), hydrogen and carbon monoxide. Unreacted hydrogen and carbon monoxide, together with the oxidation products, are then fed to the combustion chamber. Air containing oxygen that hasn't been used in the course of conversion in the high temperature fuel cell is also supplied to the combustion chamber from the air duct outlet of the fuel cell.

The outlet of the combustion chamber is connected to the volume expansion engine. As hot gases expand in the volume expansion engine, they perform mechanical work.

A portion of the hydrogen and carbon monoxide, together with oxidation products (carbon dioxide and water vapor) from the fuel outlet of the high temperature fuel cell is fed again to the reformer inlet via the distributor. The increased concentration of carbon dioxide and water vapor in the reformer increases its efficiency and output.

This power plant design results in better load following capabilities and more efficient operation than the first design, because the distributor makes it possible to redistribute the flow of fuel from the outlet of the high temperature fuel cell either to the combustion chamber (in which case the power of volume expansion engine will increase rapidly) or back to the reformer (in which case the fuel efficiency of the fuel cell will increase). For example, as the demand for cold air grows, a larger amount of fuel will be fed from the outlet of the high temperature fuel cell to the volume expansion engine, thus raising its power; this, in turn, increases the output of the compression refrigerating plant. The opposite is also true: as the demand for cold decreases, the more fuel will be fed from the outlet of the high temperature fuel cell back to the reformer thus increasing the fuel efficiency and increasing the production of electric power.

The combustion chamber may be connected to the reformer via a heat exchanger for the purpose of heating the reformer. Such an arrangement permits one (as in the first design) to intensify the processes taking place in the reformer and to employ a volume expansion engine built with low-temperature materials.

In addition, heat exchangers may be installed on said high temperature fuel cell for the purpose of additional heating of fuel fed to the reformer and air supplied to the high temperature fuel cell. Installation of said heat exchangers would additionally increase the power plant efficiency.

An additional pump that increases the pressure of products supplied from the output of the reformer can be installed between the reformer and inlet of high temperature fuel cell. This may be done to ensure that adequate amounts of hydrogen and carbon monoxide, together with oxidation products, carbon dioxide and water vapor, are supplied for all operating modes of the power plant (including the case when all said products are again fed to the reformer inlet from the distributor outlet). In the general case, an additional pump may be installed in other places—for instance, downstream of the distributor.

As with the first design, to produce additional electric power, the volume expansion engine may be connected to an electric generator.

A heat exchanger may be installed at the exhaust outlet of the volume expansion engine for the purpose of heating water to be used, for example, in hot water and water supply systems; and/or air to be used in the air conditioning system; and/or air to be fed to the air duct of the power plant.

In addition, the volume expansion engine may be connected via a mechanical drive to the compression refrigerating plant that may be used in the same manner as described for the first design of the power plant.

As with the first design of the power plant, the power of the fuel cell should be selected so that it is no greater than 50% of the power of the volume expansion engine.

Thus, the second design option of the power plant furnishes additional possibilities for regulating the operation of said power plant.

### BRIEF DESCRIPTION OF THE DRAWINGS

FIG. 1 is a schematic representation of an exemplary power plant embodiment according to the principles of the present invention.

FIG. 2 is similar to FIG. 1 showing an alternate embodiment.

FIG. 3 is a block diagram illustrating utilization of heat from the exhaust gases of the volume expansion engine.

FIG. 4 is a block diagram illustrating the process of heat transfer from the exhaust gases of the volume expansion engine to the evaporator of the compression refrigerating plant.

FIG. 5 is a block diagram illustrating utilization of heat from a sewage collecting system in the compression refrigerating plant.

FIG. 6 is a block diagram illustrating utilization of heat from the ventilation system airflow in the compression refrigerating plant.

FIG. 7 is a block diagram illustrating the process of fuel supply from the reformer outlet to the high temperature fuel cell by means of an additional pump.

FIG. 8 is a block diagram showing the connection of the high temperature fuel cell and the electric generator with a converter of direct current into alternating current.

FIG. 9 is a schematic diagram of an exemplary embodiment of a stationary energy center according to the principles of the present invention.

### DETAILED DESCRIPTION OF THE INVENTION

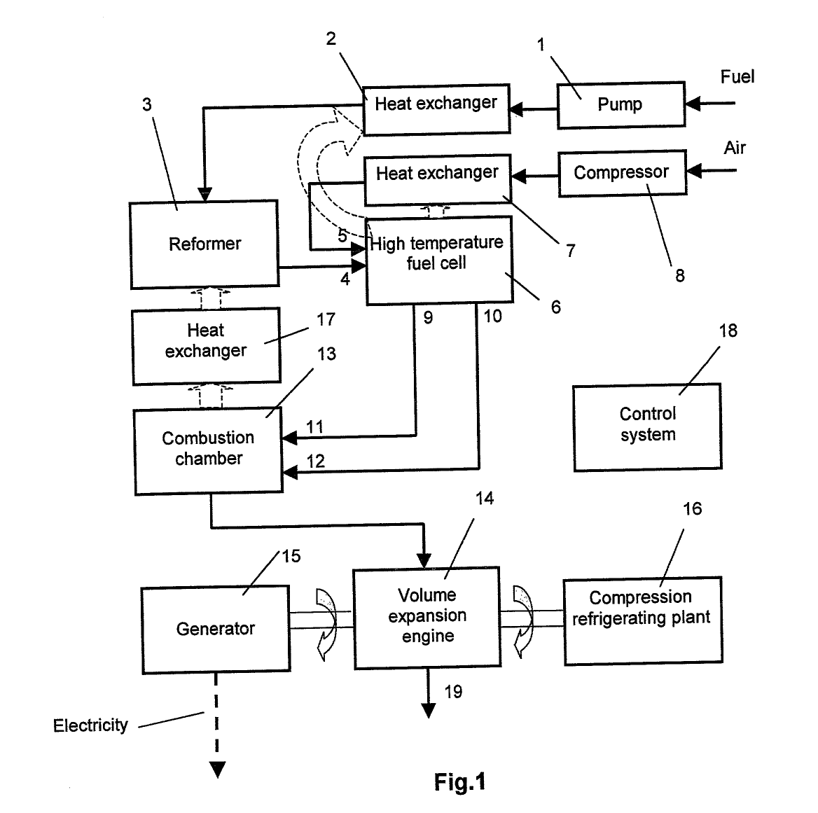

An exemplary power plant design (see FIG. 1) comprises pump 1 that feeds hydrocarbon fuel through heat exchanger 2 to the inlet of reformer 3. The outlet of reformer 3 is connected to the fuel supply channel inlet 4 of high temperature fuel cell 6. The air duct inlet 5 of high temperature fuel cell 6 is connected to the outlet of air supply compressor 8 via heat exchanger 7. Outlet 9 of the fuel supply channel and outlet 10 of the air duct of high temperature fuel cell 6 are connected to the fuel inlet 11 and air inlet 12 of combustion chamber 13, respectively.

The outlet of combustion chamber 13 is connected to the inlet of volume expansion engine 14, which is mechanically connected to electric generator 15 and compression refrigerating plant 16. Combustion chamber 13 is equipped with heat exchanger 17, which heats reformer 3. Volume expansion engine 14 may also be mechanically connected to compressors 1 and 8 (this connection is not shown in FIG. 1). Control system 18 controls the operation of the power plant (links between the control system and the power plant components are not shown in FIG. 1).

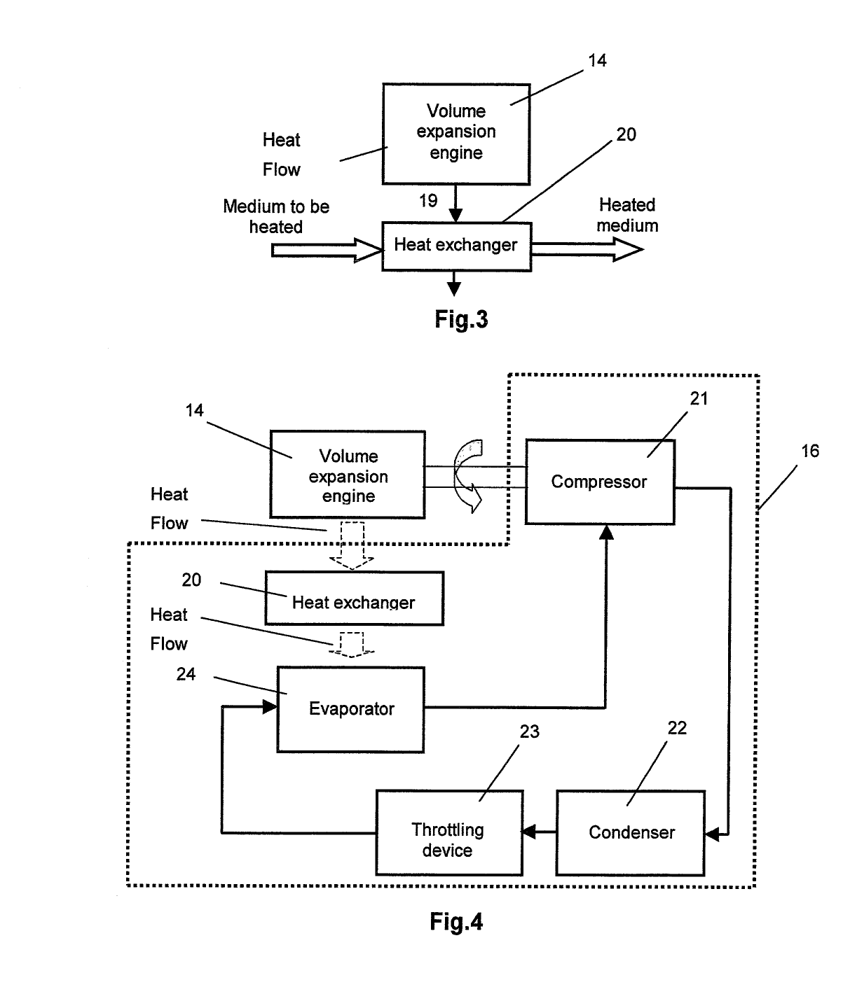

Exhaust outlet 19 of volume expansion engine 14 (see FIG. 3) is connected to the system of heat exchangers 20, by which water from the hot water and water supply systems, and/or air for the air conditioning system, and/or air for compressor 8, and/or air which heats the coolant of the compression refrigerating plant, is passed.

Compression refrigerating plant 16 (see FIGS. 4-6) comprises compressor 21 (which is mechanically connected to volume expansion engine 14), condenser 22, throttling device 23, and evaporator 24, as well as system of valves and additional plumbing (not shown) that allows to reverse the flow of refrigerant within the condenser 22, throttling device 23, and evaporator 24. The refrigerant flow reversal allows utilizing the compression refrigerating plant 16 as a heat pump for cold season operation.

In one design embodiment of the power plant (see FIG. 4), evaporator 24 receives heat from outdoor air, which can be preheated with exhausts gases of volume expansion engine 14 in heat exchanger 20, connected to exhaust outlet 19 of volume expansion engine 14. In this case the heat exchanger 20 could be as simple as a gas mixer that mixes the outside air with the exhausts gasses. Alternatively (not shown), the evaporator 24 receives heat directly from the exhausts gases of volume expansion engine 14. Still another alternative (also not shown) is to heat indoor air directly in a separate heat exchanger, using the exhaust heat from volume expansion engine 14. This could also be done in addition to preheating the air in the heat exchanger 20.

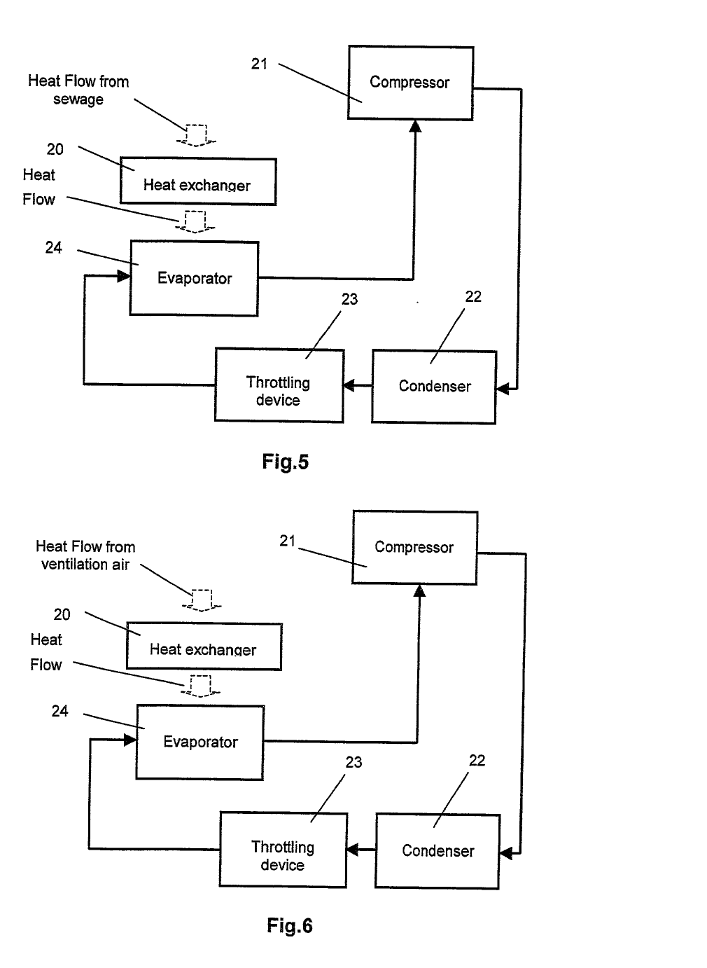

In another design embodiment of the power plant (see FIG. 5), in addition to or instead of heat from gases outgoing from the volume expansion engine 14, the evaporator 24 receives heat from the sewage collecting system of the building in heat exchanger 20.

In yet another design embodiment of the power plant (see FIG. 6) in addition to or instead of heat from gases outgoing from the volume expansion engine 14 and/or heat from sewage, the evaporator 24 receives heat from the airflow of the ventilation system of the building in heat exchanger 20.

Typical suitable refrigerants include Chlorofluorocarbon (CFC), such as CFC-11, CFC-12, CFC-113, CFC-114, and CFC-115. Some of them are more harmful to the environment then others. Many other types are sold under various trade names.

Volume expansion engine 14 may be made with a drive that executes rotary or reciprocal motion. The designs of electric generator 15 and the compressor of compression refrigerating plant 16 are chosen depending on this.

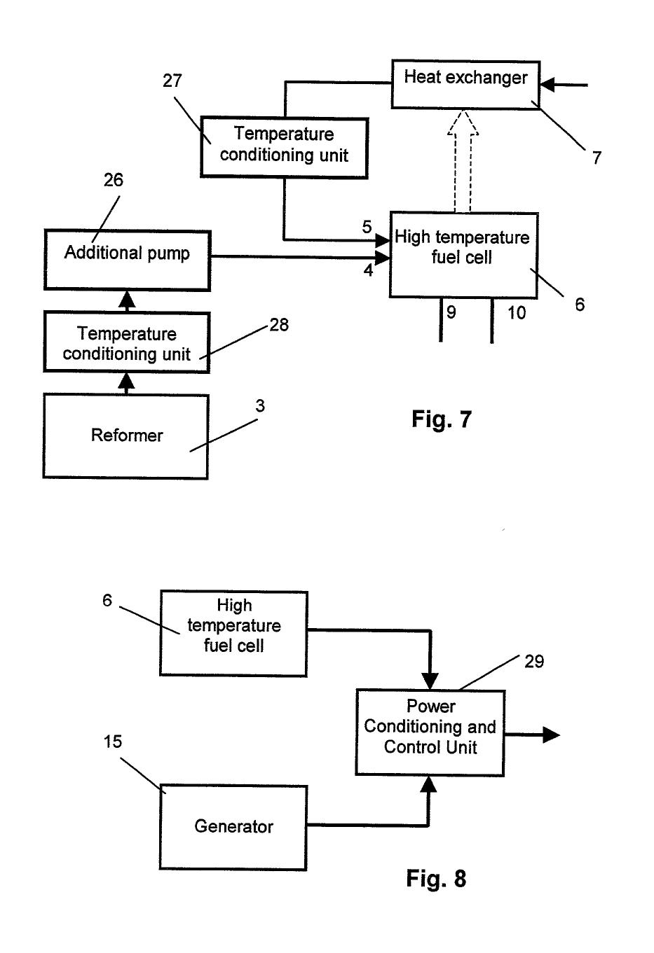

To set the required temperature for the flows of both the air and hydrogen-carbon monoxide mixture (fed from reformer 3), temperature regulation devices 27 and 28 may be installed upstream of the inlet of the high temperature fuel cell 6 (FIG. 7). The hydrogen-carbon monoxide mixture may be fed from reformer 3 by means of an additional pump 26 (FIG. 7).

Volume expansion engine 14, compressors 8 and 21, pumps 1 and 26, and generator 15 may be placed on the same axis thus forming a very simple, inexpensive and integrated system.

During certain periods, a power plant operating in a building may produce more electric power than is needed. At these times, if the system is hooked up to an external power grid, a portion of the produced energy may be exported to the grid. In other cases, namely, in the conditions of increased demand for electric power, additional amounts of electric energy from the grid may be needed. In order to make such exchanges of electric power possible, a special electric transducer 29 is provided in the power system (FIG. 8). This electric transducer is connected to the outlets of the high temperature fuel cell 6 and electric generator 15. Transducer 29 converts direct current into alternating current.

The first power plant design operates as follows.

Hydrocarbon fuel (e.g., methane) is fed by pump 1 (FIG. 1) to reformer 3 through heat exchanger 2 (where it is additionally heated by heat from high temperature fuel cell 6). Water vapor may be also fed to reformer 3. In reformer 3, the hydrocarbon fuel is converted into a mixture of hydrogen and carbon monoxide. Additional heating of reformer 3 (which operates at 600-850° C.) using high grade heat from combustion chamber 13 via heat exchanger 17 makes it possible to increase the output of hydrogen and carbon monoxide.

Electrochemical reactions involving hydrogen and carbon monoxide, and air (oxygen) proceed in high temperature fuel cell 6. Electric power is produced as a result of these reactions. A fuel cell with solid-oxide electrolyte (e.g., mixed oxides of zirconium and yttrium) may be used. The operating temperature of such a fuel cell is 600-1000° C. The heat from high temperature fuel cell 6 may be used to heat air by means of heat exchanger 7. The same heat may be used to heat hydrocarbon fuel by means of heat exchanger 2.

Oxygen-containing air that is required for the operation of high temperature fuel cell 6 is supplied by means of compressor 8 through heat exchanger 7.

The remnants of air and fuel are fed from outlets 9 and 10 of high temperature fuel cell 6 to combustion chamber 13 where the fuel is combusted; the combustion products are then supplied to volume expansion engine 14. Combustion chamber 13 may be made as a separate unit or it may be incorporated in volume expansion engine 14 (as is usually done in internal combustion engines).

A portion of the heat from combustion chamber 13 is then fed to reformer 3 (via heat exchanger 17), which increases reformer efficiency (as mentioned above). The presence of heat exchanger 17 on combustion chamber 13 in a particular embodiment of the present invention reduces the temperature of combustion products that are fed to volume expansion engine 14. Therefore, volume expansion engine 14 can operate at a lower temperature.

In a design option under consideration, in order to increase the power production, it is possible to feed more fuel either to reformer 3 (connected to high temperature fuel cell 6) or to combustion chamber 13. In this case, un-reacted fuel and air (oxygen) would be burned in combustion chamber 13 and converted into a working medium for use in volume expansion engine 14, which, in turn, will generate additional power with electric generator 15.

Piston engines, rotary engines, free-piston engines, axial piston engines, and other similar types of engines can be used as volume expansion engine 14. These types of engines perform well under dynamic loads.

Volume expansion engine 14 drives electric generator 15. It can also drive pump 1 and compressor 8.

Compression refrigerating plant 16 produces cold or hot air for the building.

Depending on the season, weather conditions, and the requirements of the consumer, the energy of volume expansion engine 14 is either converted into electric energy by electric generator 15, or used to operate compression refrigerating plant 16. When maximum output of compression refrigerating plant 16 is needed, it is possible to drive it with volume expansion engine 14 and electric generator 15 (in electric motor mode) concurrently. Generator 15 of the power plant can be constructed as an electric motor/generator. In spring and/or fall, heating and cooling are not necessary; generator 15 will operate in generator mode to produce electric power. In summertime (wintertime), when it is necessary to cool (heat) the building, generator 15 will operate in the electric motor mode and produce the additional mechanical energy needed to drive the refrigerating plant compressor (heat pump).

In addition, recovery of the energy contained in gases that exit volume expansion engine 14 is also possible. This can be done by heating indoor air in a separate heat exchanger or, by heating evaporator 24 of compression refrigerating plant 16 with these gases either directly or using an intermediate heat carrier, such as outdoor air mixed with heat expansion engine exhaust gases which mixture can then be used in evaporator 24.

Recovery of energy to the power plant is also possible by utilizing heat in the air exiting the ventilation system and heat contained in flows to the sewage collecting system. This is achieved through contact of this heat with evaporator 24 of compression refrigerating plant 16.

Gases exiting exhaust outlet 19 of volume expansion engine 14 (see FIG. 3) give up heat to water (for the hot water and water supply systems) in the system of heat exchangers 20, to air for air conditioning, to air for compressor 8, and to air that heats the refrigerant for the compression refrigerating plant.

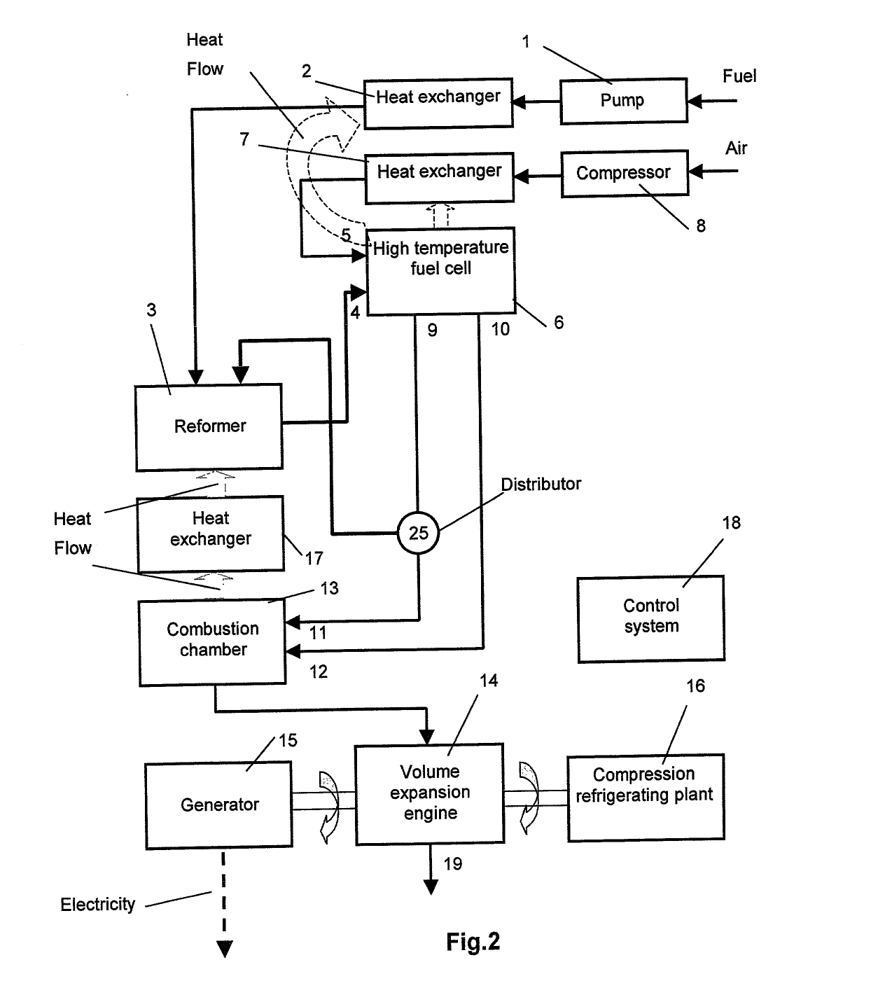

The second power plant design (see FIG. 2) is as follows. Pump 1 feeds hydrocarbon fuel through heat exchanger 2 to the inlet of reformer 3. The outlet of reformer 3 is connected to the fuel supply channel 4 of high temperature fuel cell 6. Inlet 5 of air duct of high temperature fuel cell 6 is connected to the outlet of air supply compressor 8 via heat exchanger 7. The fuel supply channel outlet 9 of high temperature fuel cell 6 is connected, via distributor 25, to fuel inlet 11 of combustion chamber 13 and to the additional inlet of reformer 3. Air duct outlet 10 of high temperature fuel cell 6 is connected to air inlet 12 of combustion chamber 13. The outlet of combustion chamber 13 is connected to the inlet of volume expansion engine 14. Combustion chamber 13 is equipped with heat exchanger 17 that heats reformer 3. Control system 18 controls the operation of the power plant (links from the control system to power plant components are not shown in FIG. 2).

As with the first design, volume expansion engine 14 is also mechanically connected to electric generator 15 and compression refrigerating plant 16.

Other components of the power plant are the same as in the first design.

The second stationary power plant design operates as follows.

As with the first design, hydrocarbon fuel (e.g., methane) is fed by pump 1 to reformer 3 via heat exchanger 2 (where it gets further heated). In reformer 3, the hydrocarbon fuel is converted to a mixture of hydrogen and carbon monoxide.

Control of the power plant (second design) under dynamic loads is achieved by recovering products from the fuel supply channel outlet of the high temperature fuel cell 6 via distributor 25, which increases the performance of reformer 3. When the power plant operates in startup mode, fuel supply channel outlet 9 of high temperature fuel cell 6 is connected to combustion chamber 13; the products of combustion chamber 13 drive volume expansion engine 14. When the power plant operates in steady-state mode, fuel supply channel outlet 9 of high temperature fuel cell 6 is connected to the additional inlet of reformer 3 via distributor 25. The amount of gas to be recycled can be varied within a wide range (0-95%) by means of distributor 25.

Electric power is produced in high temperature fuel cell 6. The remnants of air and fuel are fed from the outlets 9 and 10 of high temperature fuel cell 6 to combustion chamber 13 where the fuel is combusted, and the combustion products are then supplied to volume expansion engine 14.

Operation of the power plant under dynamic loads is made possible by distributor 25, which feeds the flow from fuel supply channel outlet 9 of high temperature fuel cell 6 to either combustion chamber 13 or to the additional inlet of reformer 3, as needed. Pump 26 delivers additional pressure when products are taken from the outlet of reformer 3 and fed back to high temperature fuel cell 6 (FIG. 7). Compared to the first design of the invention claimed herein, this design offers more flexibility in regulating power plant performance by redistribution products from fuel supply channel outlet 9 of high temperature fuel cell 6 to either combustion chamber 13 or to the inlet of reformer 3.

Otherwise operation of the second power plant embodiment is similar to that of the first power plant embodiment.

A stationary power-producing center for a house or industrial building can be created based on the power plant disclosed herein. In this case, either design of the present power plant may be supplemented with devices ensuring the optimal performance of the system. Among these are accumulators for hydrocarbon fuel and air, in which pressure fluctuations in fuel and air supply channels, are minimized. In addition, a power-producing center may include thermal accumulators that smooth out the loads on heating and cooling systems. (Accumulator for refrigerant can be used to reduce the size of heat pump or enhance system performance. Additional fans will be responsible for supplying air inside the building and drawing air out of the building. In cold seasons, this air would be heated by a heat exchanger and in hot seasons this air would be cooled by a refrigerating plant. A special computer-based control system (equipped with the required sensors and switching elements) may be used to perform all functions of controlling the operation of the stationary power-producing center. Alternatively, system operation may be controlled remotely using a communication line.

The high temperature fuel cell produces sufficient electrical power to nearly cover the average load demand for the building. The remaining energy needed to cover the average load will be produced by an electric generator driven by a volume expansion engine. This design makes it possible to use a fuel cell of a lower rated output power and size of a fuel cell because it only needs to meet the average demand for energy, rather than the peak demand. Peak demand is met by the volume expansion engine, which is capable of operating under widely varying load demands.

The power plant herein offers the following advantages.

The use of a volume expansion engine and the possibility for regulating fuel supply to the combustion chamber improves the ability of a power producing system to meet the demand for greater changes in load. By efficiently utilizing combustion chamber heat and returning a portion of the products from the outlet of the fuel supply channel of the high temperature fuel cell to the reformer, fuel efficiency and overall efficiency of the power plant are increased.

### EXAMPLE

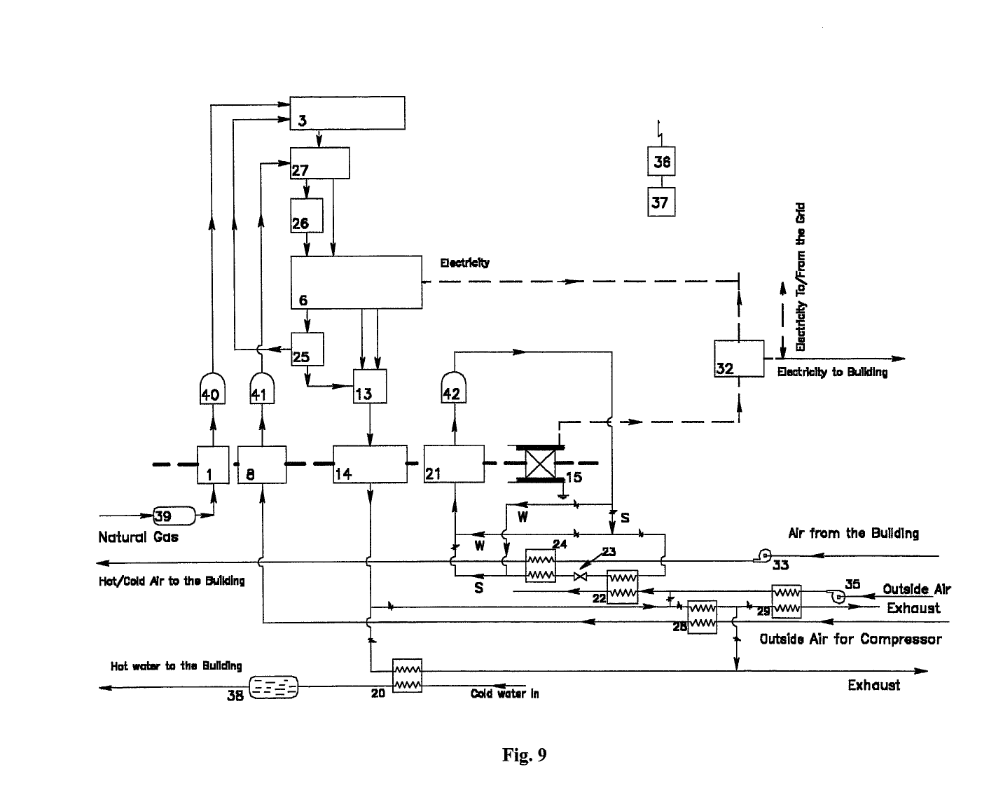

With reference to the exemplary stationary energy center (SEC) embodiment of FIG. 9, gaseous fuel, such as natural gas after desulphurizer 39 enters into natural gas Compressor 1, where its pressure is increased to optimal operating system pressure. The compressed natural gas then enters accumulator 40, which minimizes the variation of natural gas pressure in the system, and enters into reformer 3. It can be, optionally, heated before it enters the reformer (the heat exchanger for this purpose is not shown). Alternatively, the reformer 3 could obtain the heat required for reforming from the burner 13, via optional heat exchanger, which is also not shown on the diagram for clarity.

After the reformer 3, the reformed gas, containing the mixture of hydrogen and carbon monoxide and other gasses, enters the temperature-conditioning unit 27, which also receives compressed air from accumulator 41, at the pressures close to those of natural gas. The accumulator 41 receives air from air compressor 8. The temperature-conditioning unit 27 equalizes and adjusts the temperature of reformed gas and air to values needed by the High Temperature Fuel Cell (HTFC) 6, such as SOFC.

The HTFC 6 transforms chemical energy of fuel into direct current electricity, shown by dashed lines, and exhaust, consisting of high temperature gases (mostly CO2, and N2) and some unburned (i.e. un-reacted) fuel and air.

The optional additional pump 26 raises slightly the natural gas pressure above those in reformer 3. This allows recirculation of exhaust gases from HTFC 6 to the reformer 3. This recirculation improves reforming process and overall efficiency of the SEC system. The amount of recirculating fluid could be varied in wide ranges from 0 to 75% by the distributor 25.

The HTFC 6 produces DC electricity in the amount almost sufficient to supply the building with average electrical loads. The remaining average power will come from the electrical motor/generator 15 driven by heat engine 14. This design of SEC allows reducing the nominal power and size of the fuel cell stack by designing it to handle only the average power load and by enabling maximum power via additional heat engine 14, which is capable of performing under the widely variable load conditions. The heat engine 14 receives energy from the exhaust gases of HTFC 6, which are fed to HTFC 6 at higher rate than HTFC 6 could consume. These gases are burned in burner 13, which may or may not be internal to the heat engine 14. Thus all chemical energy of the fuel is fully utilized. The thermal energy of the gases is being converted into mechanical work by the said heat engine 14. The engine, in turn, could optionally drive the electrical motor/generator 15 in addition to natural gas compressor 1 and air compressor 8. The electrical motor/generator 15 produces extra electrical energy consumed by Building's loads. The power conditioning and control unit 32 transforms direct current electricity, produced by unit 6 and alternating current (AC) electricity produced by motor 15 into alternating current comparable with electrical grid current. In addition, it allows interfacing of SEC with electrical grid, so excessive amount of electricity could be optionally sold to the grid or purchased from the grid.

In addition to driving the units 1, 8 and 15, the heat engine is capable of driving a refrigerant compressor 21, which serves for cooling or heating air entering the building during the summer or winter months, correspondingly. The advantage of such arrangement is that it reduces the nominal power required by refrigerant compressor 21 because compressor 21 operates directly under steady loads, rather then intermittent on-off loads that are typical in modern heat pumps. An optional refrigerant accumulator 42 serves the same purpose as well, i.e. it aids in reducing the size of power required by refrigerant compressor 21. This, in turn, further reduces the maximum power required for SEC generation.

During the spring and fall seasons, when air conditioning or heating is not required, the electrical motor/generator 15 works in generator mode, producing AC electricity. In the summer or winter, however, when cold or hot air is required, a refrigerant compressor 21 kicks in, which may require more power then heat engine 14 can deliver. In this case, the electrical motor/generator 15 works as a motor, delivering needed extra power to refrigerant compressor 21.

Control of the heat-engine/compressors group can be accomplished by:

Controlling the amount of electricity generated or delivered to compressors by electrical motor/generator. In extreme cases, during the summer, the engine works at increased rate and all excess power generated by the engine plus some or all power generated by HTFC 16 is delivered to the compressors.

Controlling the pressure in the compressors via pressure sensitive valve. Example of such a control is during the spring/autumn months of the year, when refrigeration compressor 21 is running in idle mode (pressure set to zero) because neither cooling nor heating is needed.

Combination of two above.

Heat pump, comprised of refrigerant compressor 21, optional compressed refrigerant accumulator 42, heat exchangers 24 and 22, which interchange the functions of condenser unit and evaporator unit during summer/winter months, and expansion valve 23, works during the summer in air conditioning mode. The heat pump employs the same basic principle as the common household refrigerator, extracting heat from a space at low temperature and discharging it to another space at higher temperature.

Arrows, labeled “S”, indicate flow of refrigerant during the summer months, while those labeled “W”, indicate flow of refrigerant during the winter months.

In order to conserve the fuel during the winter months, the system can be used in the heat pump mode, as required, for heating. This is accomplished by reversing the direction of the refrigerant flow with valves. One problem, inherent to all heat pumps operating in cold regions, is that heat pump cannot heat the air sufficiently to satisfy the heat load requirements. To solve this problem, the incoming outside air can be preheated in optional air pre-heater 29 by the heat of exhausting gases or by directly mixing the exhaust gases with outside air.

The air pumped from the building by fan 33 is heated/cooled in heat exchanger 24.

The heat engine 14, all the compressors and Electrical Motor/Generator may sit on a single shaft, constituting a very simple and inexpensive Integrated Free Floating Piston System (IFFPS)—shown on FIG. 9 by heavy dashed line. This arrangement, especially if made symmetrical, has very low vibration. Also, frictional losses are small due to the absence of side loads, which are typical in engines with crankshafts. Other designs, with multiple pistons or with rotary heat machinery are also possible. Additional elements of the SEC are:

An optional water tank 38 that collects water heated in a water heater 20 that may use the remaining heat of exhausts from the system.

An optional air-preheater 28 for compressed air with bypass (not shown on FIG. 9)

Fan 35 that moves outside air through heat exchangers 29 and 22.

A computer 37, which controls all valves and decides the most optimal system parameters (for example, when it is more beneficial to buy the energy from the grid, rather then to produce it on site, subject to time of the day, temperature conditions, remaining life time of the device, etc. Sensor inputs as well as valve and other apparatus setting inputs to computer 37 are not shown in FIG. 9 for simplicity.

Wireless Internet link 36, with the following capabilities of sending information:

To Utilities/Service Centers (Data may include: Power Generated, natural gas consumed, diagnostic information)

From Utilities/Service Centers (Credits for Electricity produced, Cost of electricity purchasing, notification about maintenance scheduled visits, requests to produce extra power during the pick hours, etc.)

From Home (hot/cold air temperatures, hot water temperatures and all other settings)

To Home (status reports, etc.)

The Stationary Energy Center can operate in number of different modes, some of which are described below.

1. Fuel cell (FC) only mode; heat engine is shutoff, air for FC is not compressed and FC operates under atmospheric pressures at or below nominal power levels. The engine is by-passed or keep it in “pass through” state, i.e. hot gases pass trough the engine without causing its expansion. Heat generated by FC may be used for heating of hot water in heat exchanger 20 and/or heating indoor air in heat exchanger 24 (the line from heat engine to heat exchanger 24 is not shown);

2. FC+heat engine mode; heat engine operates at powers sufficient to drive air and fuel (natural gas) compressors. FC is pressurized and its power is increased by as much as factor of 3 or more—we call such an FC a “boosted FC”. Heat generated by FC and heat engine may be used for heating of hot water in heat exchanger 20 and/or heating indoor air in heat exchanger 24 (the line from heat engine to heat exchanger 24 is not shown);

3. FC+heat engine+electric generator+refrigeration compressor; heat engine 14 operates at powers exceeding the need of air compressor 8. The excess of power drives electrical motor/generator 15, which generates electricity and, optionally, refrigeration compressor 21, which cools or heats indoor air. FC is pressurized and its power is increased, compared to unpressurized state by as much as factor of 3 or more. Heat generated by FC and heat engine may be used for heating of hot water in heat exchanger 20 and/or heating preheating an outside air in heat exchanger 29;

4. FC+heat engine+electric motor+refrigeration compressor; heat engine 14 operates at powers sufficient to drive an air compressor 8. FC is pressurized and its power is increased (by as much as factor of 3 or more). The electricity produced by “boosted” FC powers motor/generator 15, which together with heat engine 14 drives refrigeration compressor 21, which, in turn, cools or heats indoor air. Heat generated by FC and heat engine may be used for heating of hot water in heat exchanger 20 and/or heating preheating an outside air in heat exchanger 29;

Other variations of modes described above are possible (for, example, when air compressor is turned off). The best mode of operation is determined by computer 37 on the basis of criteria set by users, such as minimizing the total cost of ownership (sum of capital and operational costs), or operational costs, or maximizing lifetime of equipment, or noise level, etc.

1. A power plant predominantly for houses or industrial buildings, comprising
(a) a reformer for converting hydrocarbon fuel into a fuel mixture consisting predominantly of hydrogen and carbon monoxide;
(b) a high temperature fuel cell having an air duct with an inlet and outlet and fuel supply channel also having an inlet and outlet;
(c) a combustion chamber having a fuel inlet, an air inlet and an outlet;
(d) a volume expansion engine having an inlet for the working medium;
wherein the reformer outlet is coupled to the inlet of the fuel supply channel of the high temperature fuel cell, the outlet of the fuel supply channel of the high temperature fuel cell is coupled to the fuel inlet of the combustion chamber, and the outlet of the air duct of the high temperature fuel cell is coupled to the air inlet of the combustion chamber, and the outlet of said combustion chamber is coupled to the volume expansion engine.

2. The power plant of claim 1, further comprising a heat exchanger for heating the reformer coupled between said combustion chamber and said reformer.

3. The power plant of claim 1, wherein said high temperature fuel cell further comprises a heat exchanger for additional heating of fuel fed to said reformer.

4. The power plant of claim 1, wherein said high temperature fuel cell further comprises a heat exchanger for additional heating of air fed to the high temperature fuel cell.

5. The power plant of claim 1, wherein a heat exchanger system operative with the exhaust outlet of the volume expansion engine, said system for heating water to be used in water supply facilities, or air to be used in the air conditioning system, or air prior to feeding it to a compressor, or air that heats refrigerant for a compression refrigerating plant.

6. The power plant of claim 1, wherein an electric generator is mechanically connected to said volume expansion engine.

7. The power plant of claim 1, wherein a compression refrigerating plant is mechanically connected to said volume expansion engine.

8. The power plant of claim 7, wherein the compression refrigerating plant comprises a compressor, a condenser, a throttling device, and an evaporator placed in series.

9. The power plant of claim 8, wherein the exhaust outlet of said volume expansion engine is coupled to a heat exchanger serving as an evaporator of the compression refrigerating plant either directly or thermally via an additional heat exchanger.

10. The power plant of claim 8, wherein said evaporator of the compression refrigerating plant is in thermal contact with the flows outgoing from the house or industrial building to the sewage collecting system.

11. The power plant of claim 8, wherein the evaporator of the compression refrigerating plant is in thermal contact with the airflow of the ventilation system of the house or industrial building.

12. The power plant of claim 1, wherein the power of said high temperature fuel cell is no greater than 50% of the power of said volume expansion engine.

13. The power plant of claim 1, further comprising an electrical motor/generator and a refrigeration compressor coupled to said volume expansion engine.

14. The power plant of claim 13, further comprising an air compressor coupled to said engine, and said motor/generator, and wherein said engine being operable at powers exceeding the need of said air compressor, whereby said excess engine power is used by said engine to drive said motor/generator, and whereby said fuel cell becomes highly pressurized by said air compressor via said reformer outlet to cause said fuel cell to generate high levels of heat and electricity, and whereby a portion of said high levels of heat is applied to heat exchanger for heating house or building ventilation air or water.

15. The power plant of claim 13, further comprising an air compressor coupled to said engine, and said motor/generator, and wherein said engine being operable at sufficient power to drive said air compressor, said air compressor via reformer highly pressurizes said fuel cell to generate high levels of heat and electricity and means coupling a portion of said electricity to power said motor/generator, and whereby a portion of said motor/generator power is applied to drive said refrigeration compressor.

16. A power plant, for houses or buildings, comprising:
(a) a reformer for converting hydrocarbon fuel into a fuel mixture comprising hydrogen and carbon monoxide;
(b) a high temperature fuel cell having an air duct with an inlet and outlet and fuel supply channel also having an inlet and outlet;
(c) a distributor having one inlet and two outlets;
(d) a combustion chamber having a fuel inlet, an air inlet and an outlet;
(e) a volume expansion engine having an inlet which supplies the working medium;
wherein the reformer outlet is coupled to the inlet of the fuel supply channel of the high temperature fuel cell, the outlet of the fuel supply channel of the high temperature fuel cell is coupled to the fuel inlet of the combustion chamber via the distributor, and the outlet of the air duct of the high temperature fuel cell is coupled to the air inlet of the combustion chamber, the outlet of the distributor is coupled to the reformer inlet and the outlet of the combustion chamber is coupled to the inlet of the volume expansion engine.

17. The power plant of claim 16, wherein said combustion chamber is coupled to said reformer via a heat exchanger that heats the reformer.

18. The power plant of claim 16, wherein said high temperature fuel cell further comprises a heat exchanger for additional heating of fuel fed to the reformer.

19. The power plant of claim 16, wherein said high temperature fuel cell further comprises a heat exchanger for additional heating of air fed to the high temperature fuel cell.

20. The power plant of claim 16, further comprising a pump operable between the outlet of said reformer and the inlet of the high temperature fuel cell.

21. The power plant of claim 16, further comprising a system of heat exchangers operably coupled to the exhaust outlet of said volume expansion engine for heating water to be used in hot water and water supply systems, or air to be used in the air conditioning system, or air prior to feeding it to a compressor, or air that heats a refrigerant for a compression refrigerating plant.

22. The power plant of claim 16, further comprising an electric generator is mechanically connected to said volume expansion engine.

23. The power plant of claim 13, wherein a compression refrigerating plant is mechanically connected to said volume expansion engine.

24. The power plant of claim 23, wherein said compression refrigerating plant comprises a compressor, a condenser, a throttling device, and an evaporator placed in series.

25. The power plant of claim 24, wherein the exhaust outlet of said volume expansion engine is coupled to an evaporator of said compression refrigerating plant either directly or via a heat exchanger.

26. The power plant of claim 24, wherein the evaporator of said compression refrigerating plant is in thermal contact with the flows from the house or industrial building to the sewage collecting system.

27. The power plant of claim 24, wherein the evaporator of said compression refrigerating plant is in thermal contact with the airflow of the ventilation system of the house or industrial building.

28. The power plant of claim 16, wherein the power of said high temperature fuel cell is no greater than 50% of the power of the volume expansion engine.

29. The power plant of claim 16, further comprising an electrical motor/generator and a refrigeration compressor coupled to said volume expansion engine.

30. The power plant of claim 29, further comprising an air compressor coupled to said engine, and said motor/generator, and wherein said engine being operable at powers exceeding the need of said air compressor, whereby said excess engine power is used by said engine to drive said motor/generator, and whereby said fuel cell becomes highly pressurized by said air compressor via said reformer outlet to cause said fuel cell to generate high levels of heat and electricity, and whereby a portion of said high levels of heat is applied to heat exchanger for heating house or building ventilation air or water.

31. The power plant of claim 29, further comprising an air compressor coupled to said engine, and said motor/generator, and wherein said engine being operable at sufficient power to drive said air compressor, said air compressor via reformer highly pressurizes said fuel cell to generate high levels of heat and electricity and means coupling a portion of said electricity to power said motor/generator, and whereby a portion of said motor/generator power is applied to drive said refrigeration compressor.

32. The power plant of claim 7, wherein said refrigerating plant includes a refrigerant compressor and an accumulator coupled to the outlet of said refrigerant compressor.

33. The power plant of claim 23, wherein said refrigerating plant includes a refrigerant compressor and an accumulator coupled to the outlet of said refrigerant compressor.

34. The power plant of claim 1, further comprising an air compressor coupled to said engine and an accumulator coupled to the outlet of said air compressor for accumulating and smoothing airflow supplied by said air compressor.

35. The power plant of claim 16, further comprising an air compressor coupled to said engine and an accumulator coupled to the outlet of said air compressor for accumulating and smoothing airflow supplied by said air compressor.
